(19) United States
(12) Patent Application Publication
(10) Pub. No.: US 2005/0212809 A1
(43) Pub. Date: Sep. 29, 2005

(54) Image data storing method and image processing apparatus

(75) Inventors: Takeshi Sadazumi, Tokyo (JP); Toshiyuki Kaneko, Saitama (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/077,724

(22) Filed: Mar. 11, 2005

(30) Foreign Application Priority Data
Mar. 16, 2004 (JP) P2004-074900

(51) Int. Cl. G09G 5/00; G06T 11/00; G06T 1/60

(52) U.S. Cl. 345/555; 345/629; 715/716

(57) ABSTRACT

In an image data storing method and an image processing apparatus, when background image data and data for a plurality of display objects selectively combined with the background image data for display are being stored in a predetermined memory unit, specific display object data selected from the plurality of display object data is combined with the background image data to generate composite image data; the composite image data is compression-coded and stored in the memory unit separately from the background image data; and when displaying a composite image in which the specific display object data and the background image data are combined, the compression-coded composite image data stored in the memory unit is decompressed and displayed.

### CROSS-REFERENCE TO RELATED APPLICATIONS

The present application claims priority from Japanese Application No. 2004-074900 filed Mar. 16, 2004, the disclosure of which is hereby incorporated by reference herein.

### BACKGROUND OF THE INVENTION

The present invention relates to an image data storing method and an image processing apparatus suitable to be applied to an electronic device forming, for example, various kinds of GUI (Graphic User Interface) displays.

In the past, when a GUI image based on a user operation or the like has been displayed in a display connected to an electronic device or in a display unit incorporated in the electronic device, image data constituting an image to be displayed has been stored in a memory, such as a ROM incorporated in the electronic device, and the stored image data has been read out to display the image based on the operation.

For example, consider a case in which a picture for selecting a connection state (arrangement state) of a speaker apparatus is displayed on a screen of a connected display in an audio apparatus such as a DVD (Digital Video Disc or Digital Versatile Disc) reproducing apparatus and a connection state is selected based on the screen. FIGS. 5A and 5B are views showing display examples of this case. FIG. 5A shows a display example in which a ring is displayed with a sofa with a viewer sitting positioned in the center thereof, a receiver is displayed in the front of the ring, front speakers are arranged on the right and left sides of the receiver, and a center speaker is arranged right in front of the receiver. When such a picture is displayed and a user operation is performed to fix the displayed arrangement, a stereo mode is set for sound reproduction in the corresponding speaker arrangement.

Further, FIG. 5B shows a display example in which the front speakers are arranged on the right and left sides of the receiver, and rear speakers are arranged behind the right and left sides of the sofa on which the viewer sits. When such a picture is displayed and a user operation is performed to fix the displayed arrangement, a surround mode is set for reproducing surround sound in the corresponding speaker arrangement.

When the examples of FIGS. 5A and 5B are displayed, a background image prepared in advance, for example, is displayed in a portion other than the screen for setting the speaker arrangement.

When displays such as shown in FIGS. 5A and 5B are formed, image data for elements constituting each part of the image is prepared and stored in memory means in the audio apparatus as shown in FIG. 7, for example. Specifically, a total of seven portions of image data are used, including image data for a background image 1, image data for an image 2 in which the sofa and the receiver are displayed on a ring (data for the state of the interior space), image data for the left and right front speakers 3, 5, image data for the center speaker 4, and image data for the left and right rear speakers 6, 7 (individual display data for the speakers). Each portion of image data is stored in the memory means in bitmap form.

When displaying the above, for example, as described in the table shown in FIG. 8, data on a “display layer” of objects 2 through 7 (the numerals of those objects 2 through 7 correspond to the numerals of the images shown in FIG. 7) which are display objects superimposed and displayed on the background image 1, data on a “display” showing the display mode of either FIG. 5A or FIG. 5B, and data on “coordinates” showing the horizontal and vertical positions on the coordinates when displaying are referred to and the corresponding display in each display mode is formed. In addition, as the “display layer”, settings have been made such that the background image 1 is positioned in the back, the image 2 displaying the sofa and the receiver on the ring is positioned in the middle, and each of the speaker images is positioned in the front.

Thus, an image display which can be changed based on a user operation is formed by preparing image data for elements (objects) constituting respective parts of the image and by arranging each portion of the image data in accordance with a display mode to form the image actually displayed. Published Japanese Patent Application No. H07-282269 discloses an apparatus in which data to be displayed is generated by combining a plurality of image data.

There is a limitation in the memory capacity of the memory means incorporated in the above-described electronic device displaying the GUI image and the like, and therefore if image data constituting the GUI image and the like can be stored using as little memory capacity as possible, the memory capacity of the memory means incorporated in the device can be reduced, which simplifies the device configuration. However, since the number of images to be displayed as the GUI image and the like in this kind of device actually tends to increase as the device becomes more multifunctional, there is such a problem that more memory capacity of the memory means is required.

### SUMMARY OF THE INVENTION

The present invention is made in view of such a point and aims to efficiently reduce the memory capacity required for displaying a GUI image and the like in this kind of electronic device.

A method for generating a display of display object data selectively combined with background image data according to an embodiment of the present invention includes generating composite image data in which specific display object data selected from among a plurality of display object data is combined with the background image data; compression-coding the composite image data; storing the compression-coded composite image data in a predetermined memory separately from the background image data; decompressing the compression-coded composite image data stored in the memory; and displaying an image in which the specific display object data and the background image data are combined.

Accordingly, image data is compression-coded in a unit of one screen in a state of actually being displayed or almost being displayed, and is stored in a memory.

According to this embodiment of the present invention, since image data is compression-coded in a unit of one screen in a state of actually being displayed and is stored in a memory, various kinds of GUI images and the like can be stored using less memory capacity.

In particular, since specific display object data is not stored in the memory and only the compression-coded image data combined with the background image data is stored, the memory capacity can be reduced greatly in comparison with the case in which data of each display object is stored individually in bitmap data form or the like.

The method for generating a display according to an embodiment of the present invention further includes comparing a data volume of the specific display object data with a data volume of the compression-coded composite image data; and storing the compression-coded composite image data in the memory only when the data volume of the compression-coded composite image data is less than the data volume of the specific display object data. Accordingly, the image combined with the background image data is compression-coded and stored only when such procedure is effective in reducing the required memory capacity; and processing to store the compression-coded data can be performed efficiently.

### BRIEF DESCRIPTION OF THE DRAWINGS

FIG. 1 is a block diagram showing an example of the configuration of an apparatus according to an embodiment of the present invention;

FIG. 2 is a block diagram showing an example of the configuration of an image processing unit according to an embodiment of the present invention;

FIG. 3 is a flow chart showing processing according to an embodiment of the present invention;

FIG. 4 is an explanatory view showing a display example (initial screen) according to an embodiment of the present invention;

FIGS. 5A and 5B are explanatory views showing display examples (speaker arrangement screens) according to an embodiment of the present invention;

FIG. 6 is an explanatory view showing an example of each element forming an image according to an embodiment of the present invention;

FIG. 7 is an explanatory view showing an example of each element forming an image in the related art; and

FIG. 8 is a table showing an example of the settings for individual objects.

### DETAILED DESCRIPTION

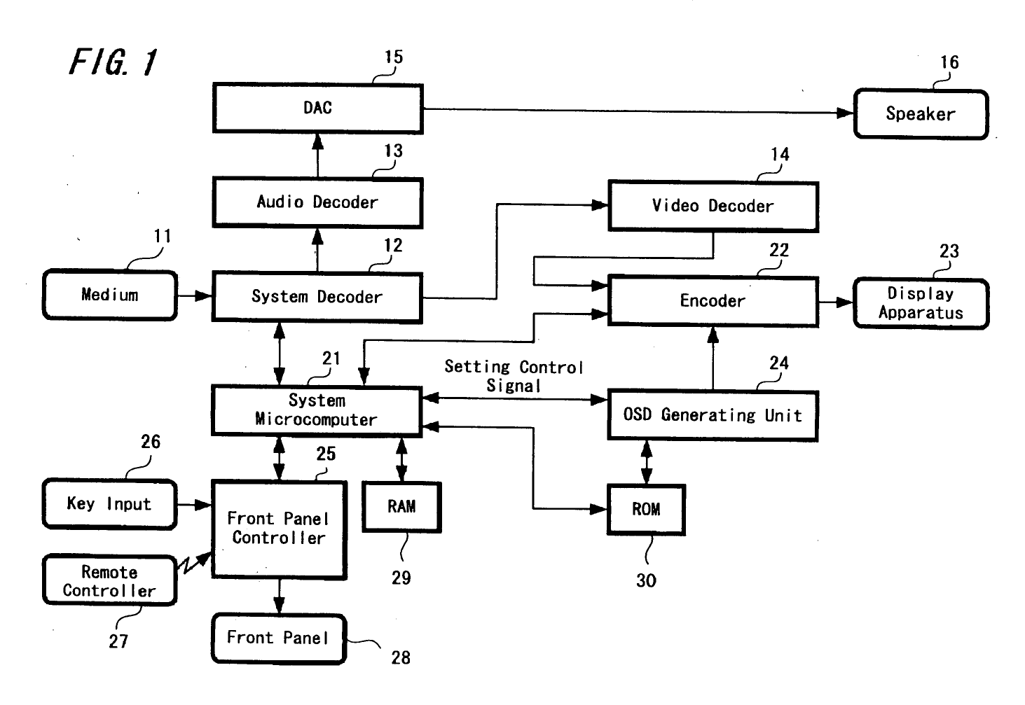

Hereinafter, an embodiment of the present invention will be explained with reference to FIGS. 1 through 6.

FIG. 1 is a diagram showing the configuration of a media reproducing apparatus to which processing according to this embodiment is applied. Data reproduced from a medium 11, such as a DVD or other optical discs or a memory card, is supplied to a system decoder 12 and is separated into video data, audio data, and the like. The audio data is supplied to an audio decoder 13 in which decoding processing is performed, and the video data is supplied to a video decoder 14 in which decoding processing is performed. The audio data decoded in the audio decoder 13 is converted into an analog audio signal in a digital-analog converter 15, and the signal is supplied to a speaker 16 to be output. In FIG. 1, a circuit such as an amplifier is omitted.

The video data decoded in the video decoder 14 is supplied to an encoder 22 and is combined with image data output from an OSD (On Screen Display) generating unit 24. The OSD generating unit 24 is a processor for generating image data to form a display (referred to as an “on screen display”) of various kinds of characters and figures on the screen of a display apparatus, and for generating a GUI image described later. In this embodiment, processing to decompress the compression-coded image data stored in a ROM 30 is further performed in the OSD generating unit 24. The image data (video data) combined in the encoder 22 is supplied to a display apparatus 23 after being made into image data of a format supplied to the display apparatus 23 in the encoder 22, and is displayed on the screen of the display apparatus (display) 23.

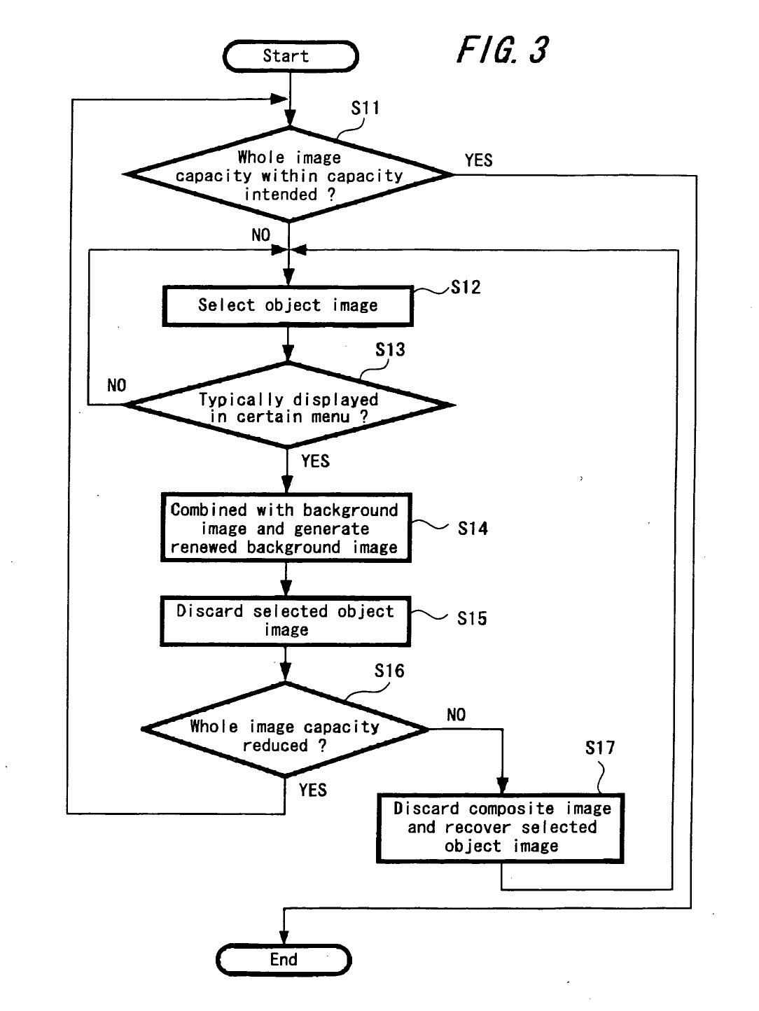

The image generating processing in the OSD generating unit 24 is performed based on a setting control signal from a system microcomputer 21. Image data for each element constituting the image data to be generated in the OSD generating unit 24 has been stored in the ROM 30, and a part of the image data stored in the ROM 30 is stored as compression-coded image data. In this embodiment, whether or not the image data is compression-coded and stored is decided at the stage of manufacturing the software installed in the media reproducing apparatus, and whether or not the image data is compression-coded and stored is determined in processing described later on (flow chart of FIG. 3). For example, an MPEG (Moving Picture Experts Group) method may be used as the compression-coding method, and the compression-coding may be performed in units of one screen displayed in the display apparatus 23. In the case in which one screen is compression-coded by the MPEG method, the data volume is reduced by a factor of several ten or less in comparison with the case in which the image data of one screen is encoded in a bitmap form.

Also connected to the system microcomputer 21 is a RAM 29 in which various kinds of operating programs and the like of the device are stored. Further, a front panel controller 25 is connected to the system microcomputer 21, and a display in a front panel 28 is formed based on an operation of a key input unit 26 or an operation of a remote controller 27. Further, in the case of an operating mode to display the GUI image and the like in the display apparatus 23, a command is sent to the system microcomputer 21 based on operating data supplied to the front panel controller 25 so as to generate corresponding image data in the OSD generating unit 24.

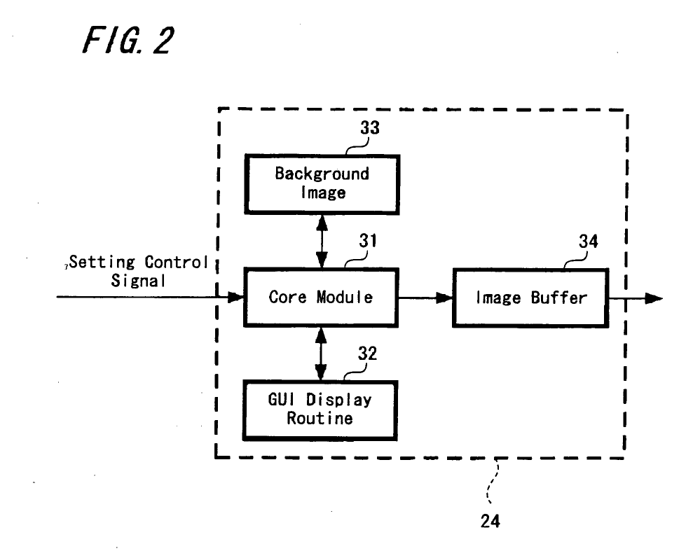

FIG. 2 is a diagram showing in detail the configuration of the OSD generating unit 24 and the periphery thereof. The setting control signal supplied from the system microcomputer 21 shown in FIG. 1 is supplied to a core module 31 in the OSD generating unit 24, the image to be generated is set in processing performed in a GUI image display routine processing unit 32, and a GUI image is generated using image data read out from the ROM 30. In this case, the image data is superimposed on a background image read out from the ROM 30 and stored in a background image storage unit 33, if necessary. Further in this embodiment, a part of the GUI image is compression-coded and stored in the ROM 30 as image data in the actual display state of one screen which is superimposed on the background image, and decompression processing of the compression-coded image is performed in the core module 31 when displaying the compression-coded image data.

The image data generated in the core module 31 is stored in an image buffer 34, and the image data stored in the buffer 34 is supplied to the encoder 22 (refer to FIG. 1) and is made into the image data to be supplied to the display apparatus 23.

Next, referring to the flow chart of FIG. 3, an explanation is made with respect to an example of a setting process at the stage of manufacturing the software incorporated in this apparatus, in which it is decided whether or not image data is to be compression-coded and stored when storing the image data constituting the GUI image in the ROM 30. First, it is determined at the manufacturing stage of the software whether the total of the volume of the prepared image data for each element constituting the GUI image in the bitmap form falls within the range of a capacity that can be used to store the GUI image in the memory means provided as the ROM 30 (Step S11). When the total volume of the image data falls within the range of the capacity that can be used to store the GUI image, all of the image data is stored in the ROM 30 as it is (for example, as bitmap data) without performing compression-coding.

When it is determined at Step S11 that the total volume of the image data does not fall within the range of the capacity that can be used to store the GUI image, a specific object image is selected from the image data constituting the GUI image (Step S12), and it is determined whether the selected object image is an image typically displayed in a certain operation menu (Step S13). When the selected object image is not one typically displayed in the specific menu, the process returns to Step S12 and another object image is selected.

Further, when it is determined at Step S13 that the selected object image is one typically displayed in the certain operation menu, the image is combined with the background image, which is an actual display mode; the composite image is made into a renewed background image used in the operation menu; and the composite renewed background image is made into image data compression-coded by a predetermined method (Step S14). In this case, the original image data for the object image selected at Step S12 is discarded from the data to be stored in the ROM 30 (Step S15).

After having performed the processing up to this point, it is determined whether the volume of data has decreased from the total volume of the image data determined at Step S11 (Step S16), and when the volume of data has decreased, the process returns to Step S11. When it is determined at Step S16 that the data volume has not decreased from the total volume of the image data before compression, the compression-coded image data generated at Step S14 is discarded; the image data for the original object image discarded at Step S15 is recovered (Step S17); the process returns to the determination of Step S11; and another object image is selected at the next Step S12.

Further, a plurality of encoding rates may be provided from which an encoding rate may be selected when compressing and coding the image data, and when it is determined at, for example, Step S16 of the flow chart in FIG. 3 that the total data volume has not decreased, compression-coding at a higher compression rate can be performed with respect to the same image data. However, the higher the compression rate becomes, the more the quality of the displayed image deteriorates. Therefore, it is necessary to determine in advance the allowable extent of compression in accordance with the intended use of the apparatus and the like.

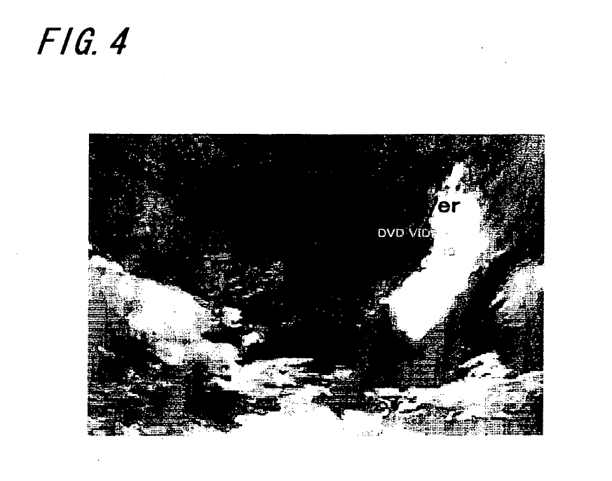

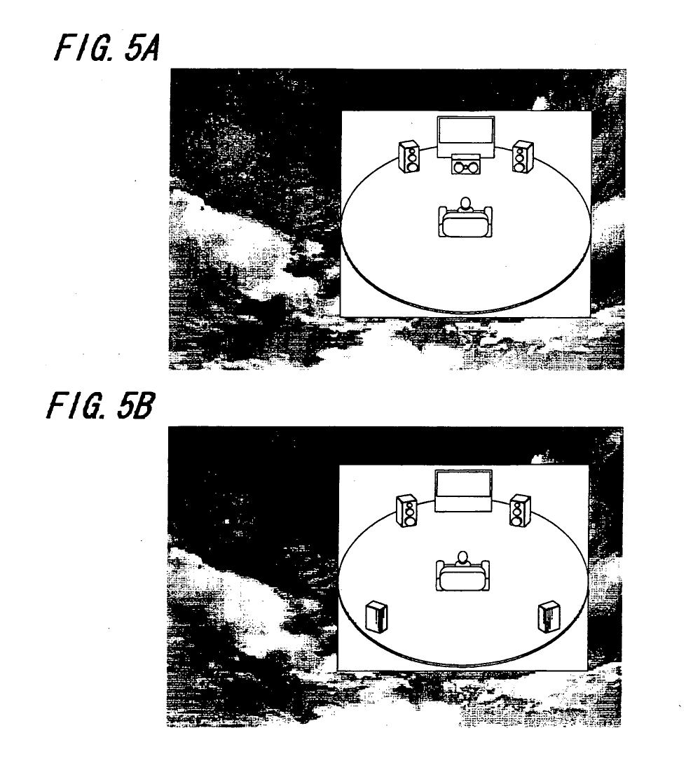

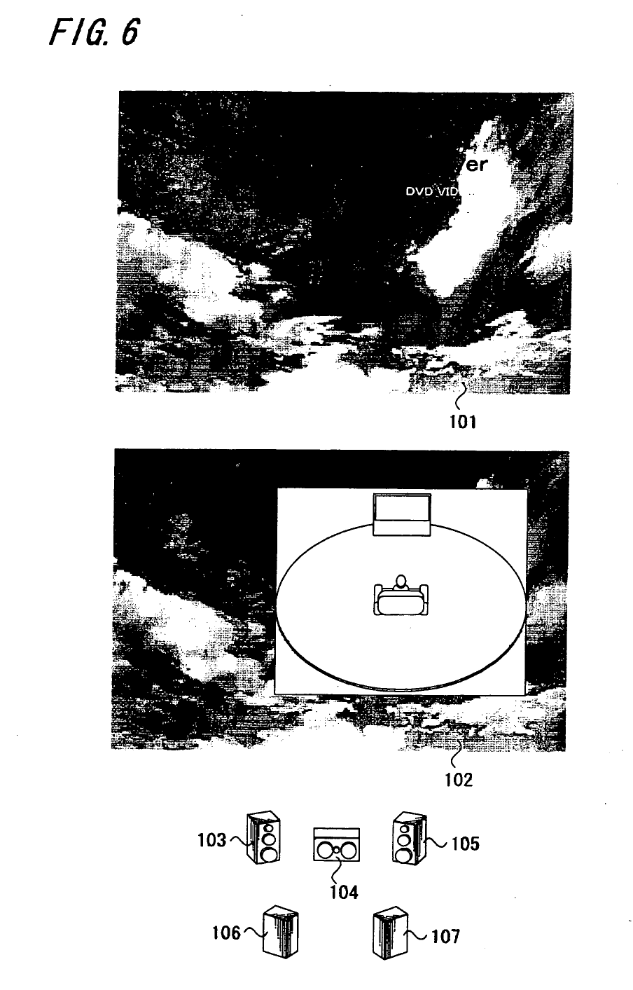

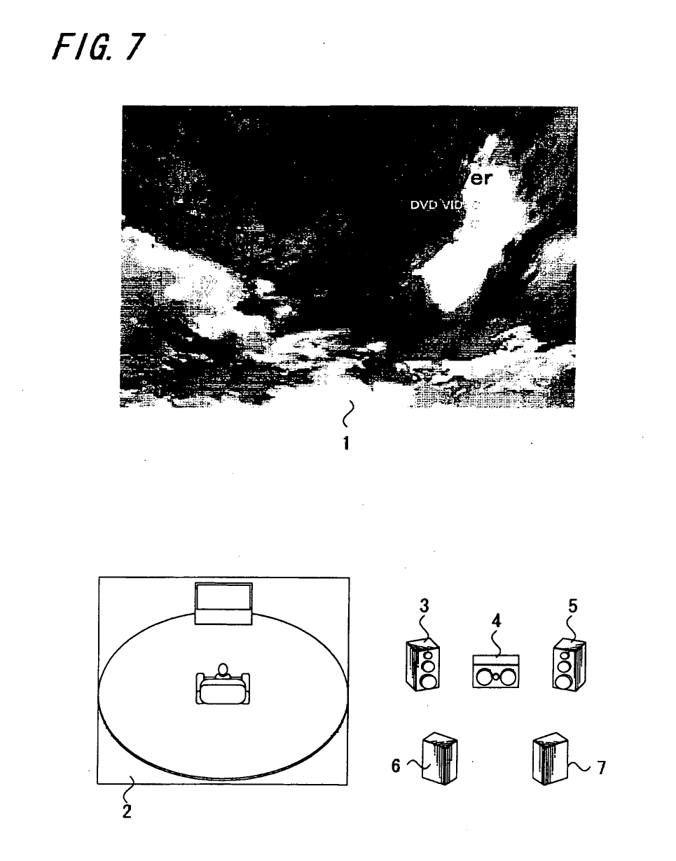

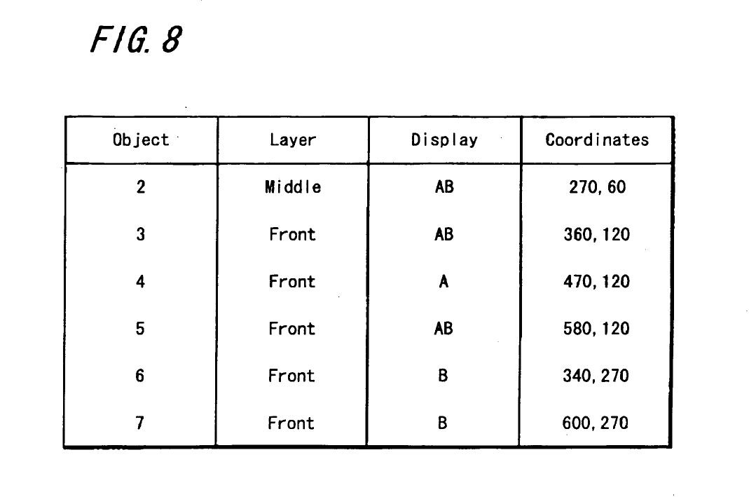

Next, an example of processing of actual image data is explained with reference to the display examples in FIGS. 4 and 5 and the example of the elements of an image in FIG. 6. Those display examples show the same image as shown in FIGS. 7 and 8 as a related art example, that is, an example of displaying a GUI image to select the arrangement of speakers connected to an apparatus.

FIG. 4 is an initial screen displayed when starting the apparatus or on an occasion like that. With this initial screen being displayed, the key input unit 26 or the remote controller 27 is operated to set a mode for selecting the speaker arrangement and an image showing either the speaker arrangement shown in FIG. 5A or that shown in FIG. 5B is displayed. With the user's operation to select the display, the apparatus is set to produce an audio output corresponding to the displayed speaker arrangement.

When such display is formed, as an example of the image data for each element constituting the display image in this embodiment, an initial screen 101 as shown in FIG. 6, for example, is stored in the ROM 30 as image data in which the image of one screen is compression-coded without change. Further, there is generated a composite image 102 in which image data (interior space status data) that displays a ring (elliptic ring) on which speakers are arranged is combined with the initial screen so as to be displayed thereon, and the image 102 is made into compression-coded image data and is stored in the ROM 30. The data volume of the compression-coded image data of the image 102 is less than the data volume of the image data in bitmap form for only the image of the portion displaying the ring on which the speakers are arranged (corresponding to the image 2 in FIG. 7).

Further, with respect to image data (individual speaker display data) 103 through 107 of the speakers arranged on the ring, since images are displayed in a small size on the screen as shown in FIG. 6 and have a comparatively small data volume even in bitmap form, the image data for the speakers 103 through 107 are stored in the ROM 30 as image data in bitmap form, and not compressed.

When the GUI image for selecting the speaker arrangement is displayed, the image data 102 is read out from the ROM 30; the process of decompressing from the compression-coded form is performed; the process of combining the required image data from the speaker image data 103 through 107 to be arranged in the decompressed image data in accordance with an operation at that time is performed; and the display image shown in FIG. 5A or FIG. 5B is generated, for example. Note that the display size of the speakers may be made selectable in a plurality of stages at the time composite processing to arrange the speaker image data 103 through 107 is performed.

In this way, since image data is stored in the ROM 30 and a GUI image or the like based on a user's operation is displayed using the stored image data, various images can be stored and displayed without increasing the memory capacity of the ROM 30 as the memory means. That is, since the compression-coding process is performed in a unit of one screen size to be displayed using a predetermined method such as the MPEG method, data compression at a high compression rate can be performed in a comparatively simple process. Further, since composite processing is performed in which comparatively small image data in bitmap form is pasted on a decompressed image of a compression-coded image, various kinds of GUI images as elements constituting an image to be stored can be displayed using data having less elements, and therefore the memory capacity can be greatly reduced in comparison with the case in which all image data constituting a GUI image is stored in bitmap form as in the related art. For example, in performing the process shown in the flow chart of FIG. 3 when manufacturing software, a greater variety of GUI images and the like than before can be displayed without increasing the memory capacity of the ROM 30 as the memory means.

It should be noted that in the embodiment heretofore explained, the processing which occurs when displaying an image in a display apparatus connected to a media reproducing apparatus such as a DVD reproducing apparatus is explained. However, it is also possible to perform similar processing when displaying a GUI image and the like in a front panel or the like incorporated in the apparatus. In addition, it is obvious that the present invention is also applicable to electronic devices other than a media reproducing apparatus which display an image, such as an internally generated GUI image, on a connected display apparatus or on an incorporated display unit. Needless to say, the content of the image to be displayed is not limited to the image of the speaker arrangement shown in the figures.

Furthermore, in the embodiment described above, the image data is compression-coded when manufacturing the software incorporated in the apparatus. However, in other cases in which image data is similarly stored in a memory means having a limited memory capacity or the like, it is also possible to determine whether the image data similarly falls within the total memory capacity of the memory means and to determine whether the image data is to be compression-coded and stored.

Moreover, although the MPEG method is described as an example of a compression-coding method and the bitmap form is described as the uncompressed form of the image data in the embodiment described above, image data compressed by other methods or in a different uncompressed form can also be used.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

1. A method for generating a display of display object data selectively combined with background image data, the method comprising:
generating composite image data in which specific display object data selected from among a plurality of display object data is combined with the background image data;
compression-coding the composite image data;
storing the compression-coded composite image data in a predetermined memory separately from the background image data;
decompressing the compression-coded composite image data stored in the memory; and
displaying an image in which the specific display object data and the background image data are combined.

2. A method for generating a display according to claim 1, wherein the specific display object data is not separately stored in the memory.

3. A method for generating a display according to claim 1, wherein the specific display object data is display data on a state of speaker arrangement.

4. A method for generating a display according to claim 1, further comprising:
comparing a data volume of the specific display object data with a data volume of the compression-coded composite image data; and
storing the compression-coded composite image data in the memory only when the data volume of the compression-coded composite image data is less than the data volume of the specific display object data.

5. An image processing apparatus for generating a display of display object data selectively combined with background image data, the apparatus comprising:
a memory operable to generate composite image data in which specific display object data selected from among a plurality of display object data is combined with the background image data, to compression-code the composite image data, and to store the compression-coded composite image data separately from the background image data;
a decompressing unit operable to decompress the compression-coded composite image data read out from the memory to produce display image data; and
an output unit operable to output the display image data.

6. An image processing apparatus according to claim 5, wherein the memory does not separately store the specific display object data.

7. An image processing apparatus according to claim 5, wherein the memory is further operable to compare a data volume of the specific display object data with a data volume of the compression-coded composite image data, and to store the compression-coded composite image data only when the data volume of the compression-coded composite image data is less than the data volume of the specific display object data.
